(19) United States
(12) Patent Application Publication
(10) Pub. No.: US 2025/0322289 A1
(43) Pub. Date: Oct. 16, 2025

(54) Item Weight Prediction with Machine Learning

(71) Applicant: Maplebear Inc., San Francisco, CA (US)

(72) Inventors: Mehdi Nikkhah, San Jose, CA (US); Lin Gao, Miami, FL (US); Yilin Huang, Shanghai (CN)

(21) Appl. No.: 18/633,296

(22) Filed: Apr. 11, 2024

(51) Int. Cl. G06N 20/00; G06N 5/022

(52) U.S. Cl. CPC G06N 20/00; G06N 5/022

(57) ABSTRACT

A smart shopping cart includes a load sensor to measure the weight of items added to the cart. To avoid waiting for the load sensor to converge, a detection system predicts the weight of items added to the storage area of a smart shopping cart based on the shape of a load curve output by the load sensor when an item is added to the cart. The detection system receives load data from the load sensor, detects that an item was added to the storage area of the shopping cart during a time period and identifies a set of load measurements captured by the load sensor during the time period. The set of load measurements comprise a load curve, to which the detection system applies a weight prediction model to generate a predicted weight of the added item.

### BACKGROUND

This disclosure relates generally to computer-implemented item recognition and more particularly to prediction of item weight using machine learning models.

Automated checkout systems automatically identify items that are collected by their users. Generally, automated checkout systems require users to scan a barcode on an item through a barcode scanner coupled to the shopping cart or enter an item manually. However, these systems can be difficult for a user to use, and do not work well when labels cannot be affixed to an item (e.g., when purchasing bulk goods).

Some automated checkout systems rely on sensors to detect items added to an automated shopping cart. For example, an automated checkout system may use a load sensor to detect the weight of an added item, such as the weight of a produce item. Although accurate in measuring weight, load sensors often take a significant amount of time to converge to a final load. For example, users may notice delays of more than a few hundred milliseconds, which is commonly the amount of time it takes for the load on a load sensor to converge. Thus, users who use automated shopping cars equipped with load sensors may be required to pause between adding items to the shopping cart to allow the load sensors to converge, resulting in a poor user experience.

### SUMMARY

A smart shopping cart may include one or more sensors to detect items added to the cart's storage area. The smart shopping cart may include one or more load sensors to measure the total weight of the storage area and the weight of items added or removed from the cart's storage area as a user shops. The smart shopping cart may also include cameras that capture image data of the storage area.

A detection system predicts the weight of items added to the storage area of a smart shopping cart based on the shape of a load curve output by one or more load sensors when an item is added rather than waiting for the load curve to converge to a final value. The detection system receives load data from the load sensor at the storage area of the shopping cart. The detection system detects, based on the load data, that an item was added to the storage area of the shopping cart during a time period and identifies a first set of load measurements captured by the load sensor during the time period. The detection system applies a weight prediction model to the first set of load measurements to generate a first predicted weight of the added item and a confidence score corresponding to the first predicted weight. The detection system determines whether the confidence score exceeds a confidence threshold. In response to the confidence score not exceeding the confidence threshold, the detection system identifies a second set of load measurements captured by the load sensor during the time period when the item was added. The detection model applies the weight prediction model to the second set of load measurements to generate a second predicted weight of the item. The detection model may predict an identifier of the item by applying an item recognition model to the first or second predicted weight of the item.

The detection system reduces the time it takes to predict the weight of an item by using information found in the load curve rather than waiting for the load curve to converge to a final weight value. To further reduce latency, in many embodiments, the detection system operates on the shopping cart rather than being separately located and communicating with the shopping cart over a network. The reduced latency in weight prediction allows the detection system to quickly predict an identifier of the item with the item recognition model.

### BRIEF DESCRIPTION OF THE DRAWINGS

FIG. 1 is a high-level block diagram of a system environment for an item detection system, in accordance with one or more example embodiments.

FIG. 2 is a high-level block diagram of a system architecture for the detection system, in accordance with one or more example embodiments.

FIG. 3 is an illustration of a shopping cart, in accordance with one or more example embodiments.

FIG. 4 is a high-level diagram of a process for applying a sensor fusion model, in accordance with one or more example embodiments.

FIG. 5 illustrates a load curve, in accordance with one or more example embodiments.

FIG. 6 is a flowchart illustrating an example method for predicting the weight of an item added to a shopping cart, in accordance with one or more example embodiments.

The figures use like reference numerals to identify like elements. A letter after a reference numeral, such as “104A,” indicates that the text refers specifically to the element having that particular reference numeral. A reference numeral in the text without a following letter, such as “104,” refers to any or all of the elements in the figures bearing that reference numeral.

The figures depict various embodiments for purposes of illustration only. One skilled in the art will readily recognize from the following description that alternative embodiments of the structures and methods illustrated herein may be employed without departing from the principles of the disclosure described herein.

### DETAILED DESCRIPTION

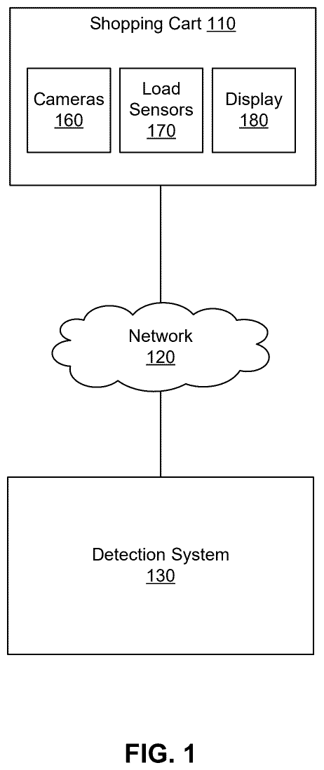

Figure (FIG.) 1 is a high-level block diagram of a system environment for an item detection system, in accordance with one or more example embodiments. FIG. 1 includes a shopping cart 110, a network 120, and a detection system 130. The shopping cart 110 includes one or more cameras 160, one or more load sensors 170, and a display 180. For clarity, only one shopping cart 110 is shown in FIG. 1. However, alternative embodiments of the system environment can have any number of shopping carts 110 and could include multiple detection systems 130. The functions performed by the various entities of FIG. 1 may vary in different embodiments. The detection system 130 manages detection of items being added to (or removed from) a shopping cart 110 and also identifies the item that was added to (or removed from) the shopping cart 110. The shopping cart 110 is a vessel that a user can use to hold items as the user travels through a store. The shopping cart 110 includes a storage area for holding items. Additionally, the shopping cart 110 includes cameras 160, load sensors 170, and a display 180.

Though referred to as a “shopping cart,” in some embodiments, the shopping cart 110 may be an on-cart computing system separately mounted to a shopping cart rather than the shopping cart itself. The one or more cameras 160, one or more load sensors 170, and display 180 may also be separately mounted to the shopping cart. Alternatively, the on-cart computing system, camera(s), and sensor(s) may be contained within a single casing that is mounted to the shopping cart. This single casing may contain all of the components needed by the on-cart computing system to perform the functionalities described herein. The single casing may be permanently mounted to the shopping cart or may be configured to be easily attached to or detached from the shopping cart. This latter embodiment may enable the on-cart computing system to be recharged at a separate station from the shopping cart or may allow the computing system to be easily mounted to pre-existing shopping carts, rather than requiring specially built shopping carts.

The one or more cameras 160 capture image data of the storage area of the shopping cart 110. Depending on the embodiment, the cameras 160 may be pointed at the bottom of the shopping cart storage area to view the current contents of the shopping cart 110, may be pointed across the opening of the shopping cart 110 storage area to capture images of items as they are added or removed from the shopping cart 110, or the cameras may be set up in some other combination of configurations. As an example, a shopping cart 110 may include four cameras 160, one attached at each corner of the storage area of the shopping cart 110. In some configurations, the cameras 160 record image data continuously as the shopping cart 110 is in use. In other embodiments, the shopping cart 110 may include some triggering mechanism, such as a light sensor, an accelerometer, or another sensor to determine that a user is about to add an item to the cart or about to remove an item from the shopping cart 110, wherein the triggering mechanism causes the cameras 160 to begin recording for some amount of time, for example a preset time range.

The one or more load sensors 170 capture load data for the shopping cart 110. In some embodiments, the one or more load sensors 170 may be scales that detect the weight (i.e., load) of the contents in the storage area of the shopping cart 110. The load sensors 170 can also capture load curves, that is, the load signal produced over time as an item is added to the cart or removed from the cart. The load sensors 170 may be attached to the shopping cart 110 in various locations to pick up different signals that may be related to items being added at different positions of the storage area. For example, a shopping cart 110 may include a load sensor 170 at each of the four corners of the bottom of the storage area of the shopping cart 110. In some embodiments, the load sensors 170 may record load data continuously as the shopping cart 110 is in use. In other embodiments, the shopping cart 110 may include some triggering mechanism, such as a light sensor, an accelerometer, or another sensor to determine that a user is about to add an item to the cart or about to remove an item from the shopping cart 110, wherein the triggering mechanism causes the load sensors 170 to begin recording for some amount of time, for example a preset time range.

The shopping cart 110 may include a display 180 through which the user can interact with information about the contents of the cart, such as via an automated checkout system. For example, the user can use a user interface presented on the display 180 to adjust the items in their shopping list, to view and confirm the items that the detection system 130 has detected in the storage area of the shopping cart 110, or to provide payment information for a checkout process. In some embodiments, the detection system may provide, for display at the user interface, an identifier and weight of an item added to the shopping cart.

In some embodiments, a user can also or alternatively interact with the shopping cart 110 information through a client device (not shown) such as a personal or mobile computing device, a smartphone, a tablet, a laptop computer, or desktop computer. In some embodiments, the client device executes a client application that uses an application programming interface (API) to communicate with the shopping cart 110 through the network 120.

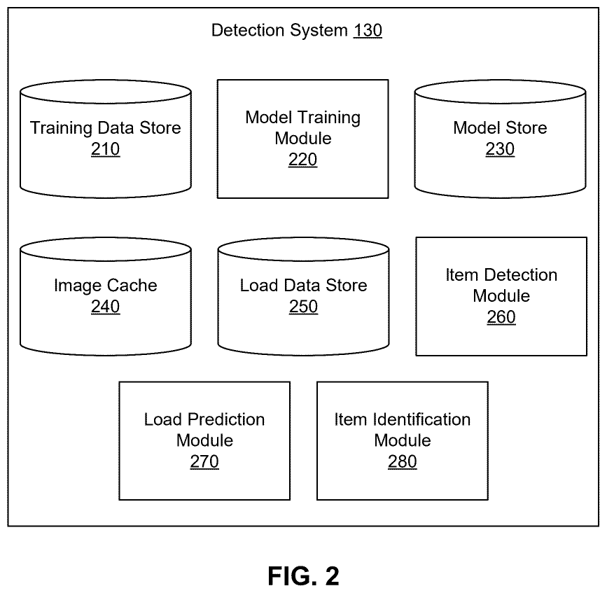

The detection system 130 uses the information obtained from the cameras 160 and the load sensors 170 to generate predictions about what items are being held in the storage area of the shopping cart 110. The detection system 130 uses the image frames captured by the cameras 160 and the load value captured by the load sensors 170 as inputs for machine learning models that are trained to identify items that a user has added to the shopping cart 110. In some embodiments, some or all functions of the detection system 130 may execute at a remote system in communication with the shopping cart 110 through network 120. However, to reduce latency associated with communicating over a network, in many embodiments the detection system 130 operates on the shopping cart 110. This arrangement reduces latency in providing weight measurements or item predictions. Additional details of the detection system 130 are presented in the description of FIG. 2.

The shopping cart 110 and the detection system 130 can communicate via the network 120, which may comprise any combination of local area and wide area networks employing wired or wireless communication links. In some embodiments, the network 120 uses standard communications technologies and protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any format, such as hypertext markup language (HTML) or extensible markup language (XML). In some embodiments, all or some of the communication links of the network 120 may be encrypted. In some embodiments, the network 120 may include Bluetooth or near-field communication (NFC) technologies or protocols.

FIG. 2 is a high-level block diagram of a system architecture for the detection system 130, in accordance with one or more example embodiments. The detection system includes various modules and data stores to identify items in the shopping cart 110 and to train detection and identification models. The detection system 130 comprises a training data store 210, a model training module 220, a model store 230, an image cache 240, a lead data store 250, an item detection module 260, a item identification module 280 and a load prediction module 270. Computer components such as web servers, network interfaces, security functions, load balancers, failover servers, management and network operations consoles, and the like are not shown so as to not obscure the details of the system architecture. Additionally, the detection system 130 may contain more, fewer, or different components than those shown in FIG. 2 and the functionality of the components as described herein may be distributed differently from the description herein.

The training data store 210 stores data that can be used by the model training module 220 to train machine learning models for the detection system 130. The training data includes load data and image data. In some embodiments, the training data may include load data from a plurality of load sensors 170 that are coupled to the storage area of a shopping cart. The load data from each load sensor 170 describes a load imparted by an item in the storage area at a different location of the storage area. Since the load sensors 170 may be placed in different positions in the storage area of the shopping cart (e.g., at each corner), the differences in load data received from each of the load sensors 170 when an item is added to the shopping cart 110 can be helpful for a model to determine where in the cart the item was placed. In some embodiments, the training data may include image frames captured from a plurality of cameras 160 coupled to the shopping cart. The image data from each camera 160 depicts the items within a field of view of a portion of the storage area of the shopping cart 110. In some embodiments, the training data is labeled. Labels on the training data may include time stamps that indicate when each load value or image frame was captured, item identifiers indicating the identity of the item, or bounding boxes identifying the location of the item in image data. The training data may also be grouped into data sets such that multiple image frames and load data values are used together as training input for an item prediction. For example, images captured within a timeframe from each of the plurality of cameras 160 attached to the shopping cart 110 and load data captured within the same or a nearby time frame from each of the plurality of load sensors 170 may be used together as inputs for training a machine learning model to identify an item in the shopping cart 110. Since the training data may be data received over a time period, this may include multiple image frames from each of the cameras 160 and multiple load values from each of the load sensors 170 (e.g., a load curve), to represent the information that is collected over a time range during which an item is added to the shopping cart 110.

The model training module 220 trains machine learning models for the detection system 130 to use for predict the weight of items added to the shopping cart, for detecting that items have been added to the shopping cart 110, and for identifying the type of item that is added to the shopping cart 110. In various embodiments, the model training module 220 trains models for use by the load prediction module 270 or the item identification module 280. The model training module 220 accesses labeled training data from the training data store 210. The training data is used to train one or more types of machine learning models. In various embodiments, the model training module 220 may train rules-based models, neural network classifier models, transformer models, or another type of model.

The model training module 220 may train a weight prediction model to predict the weight of an item based on a load curve. In some embodiments, the weight prediction model is a transformer model. Training data, which may be stored in the training data store 210, includes training examples comprising load curves produced by adding an item to the cart labeled by a ground truth weight of the item. The training data may include load curves collected from shopping carts in various states, for example stationary shopping carts or shopping carts that were moving at the time the item was added. The model training module 220 may train the model with entire load curves or with portions of load curves. In a forward pass step, the model training module 220 applies the parameters of the weight prediction model to the portion of the load curve to generate a prediction of the weight of the item. The model training module 220 computes a loss representing the difference between the prediction and the ground truth weight of the item. For example, the model training module 220 may compute the mean square error (MSE) or mean absolute error (MAE) between the prediction and the ground truth. In a backpropagation step, the model training model 220 updates the parameters of the model to reduce the loss (e.g., using gradient descent).

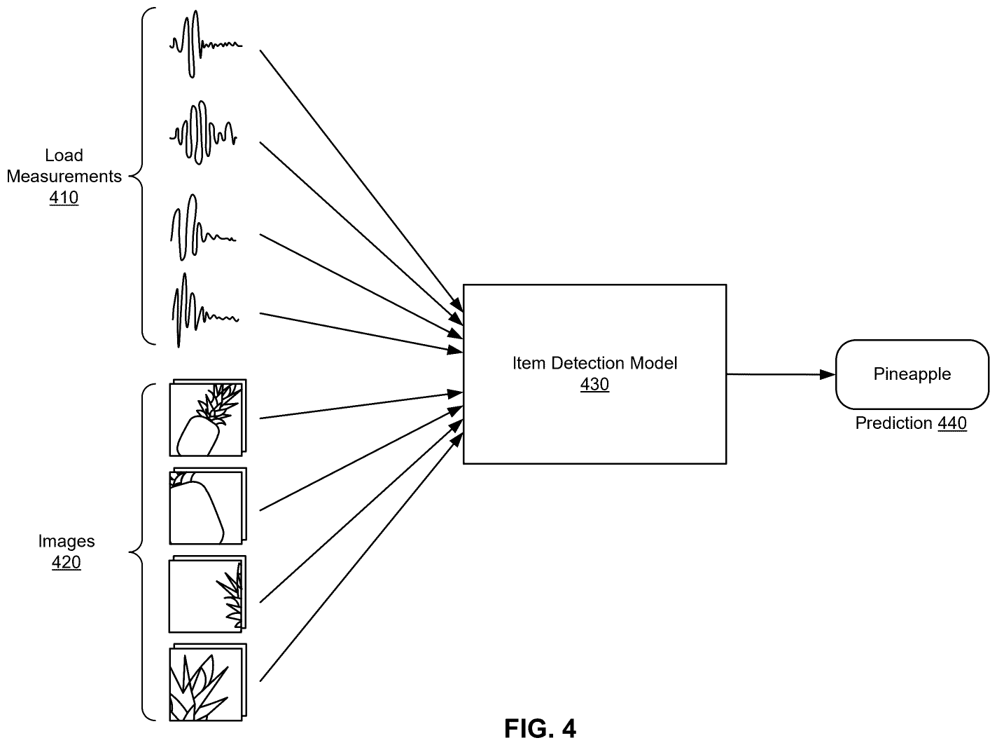

The model training module 220 may train a machine learning model that can identify an item type based on input image frames and input load data. Additionally, in some embodiments, the model training module 220 may train a machine learning model to identify, based on the load data, a set of time frames from which to select image frames for item identification. In some embodiments, the model training module 220 may train a machine learning model to generate bounding boxes or to otherwise identify the location of an item in the images of the shopping cart 110 storage area. In some cases, in addition to training models that identify items that are added to the shopping cart 110, the model training module may additionally train models to identify items that have been removed from the shopping cart 110. Additional information about the model training process is included in the description of FIG. 4.

The model store 230 stores the models generated by the model training module 220. Storing the machine learning models includes storing trained model parameters, such as the weights for trained neural network models. The model training module 220 may access and update parameters of the models stored in the model store 230 periodically, as additional training data is received, or when training is otherwise instigated, such as by a system administrator. In some embodiments, trained model parameters from the model store 230 may be deployed to individual shopping carts 110 for local item detection. In other embodiments, the shopping carts 110 may transmit data to the input data from cameras 160 and load sensors 170 to a remote detection system 130 where the models can be accessed at a model store 230 and used to generate predictions about the items in the shopping cart 110.

The image cache 240 stores image frames received from the one or more cameras 160. The images stored in the image cache 240 include metadata about which camera 160 captured each image. Additionally, each image may include a timestamp of when the image was captured by the camera 160.

The load data store 250 stores load sensor data received from the one or more load sensors 170. The load data may include metadata about which load sensor 170 captured each data point or an indication of which load sensor generated which portions of the load data. The indication may specifically identify the load sensor. For example, each measurement or set of measurements in the load data may be associated with an identifier for the load sensor that captured the measurement or set of measurements. Alternatively, the indication may include structuring the load data such that load data from a particular load sensor can be implicitly identified based on the positioning of the load data in the structure. For example, the load data may be concatenated into a large set of load data, and the load data from a load sensor is positioned in the concatenation based on a predetermined ordering of the load sensors. In some embodiments, an embedding may be generated for a set of load data from each load sensor, and the embeddings may be concatenated according to a predetermined ordering of the load sensors. In some embodiments, each data point of the load sensor data may include a timestamp of when the data was captured by the load sensor 170. The load data store 250 may store sets of load data points in a time series, herein referred to as a load curve. The load data store 250 may continually store a load curve as the shopping cart is in use or may wait for detection of an item before storing a load curve.

The item detection module 260 detects that an item has been added to the shopping cart 110 (or removed from the cart). The item detection module 260 may detect that an item has been added to the shopping cart 110 using inputs from sensors on the shopping cart 110. For example, the item detection module 260 may use information from the image data received from the cameras 160 that movement has been detected in the shopping cart 110 to determine that an item has been moved into or out of the cart. In alternative embodiments, the shopping cart 110 may include additional sensors, such as accelerometers or laser sensors that can be triggered by items being moved into the shopping cart 110. In some embodiments, the item detection module 260 uses trained machine learning models from the model store 210 to predict that an item has been added or removed from the shopping cart 110.

In some embodiments, the item detection module 260 may use information from the load sensors to determine that an item has been added to or removed from the shopping cart 110. The item detection module 260 may determine that an item has been added to or removed from the shopping cart based on a change in the load measured by the load sensor. In these embodiments, the item detection module 260 may receive a stream of load data from a load sensor. The stream of load data, a “load curve,” may include a timeseries of individual load measurements measured at a sampling rate of the load sensor (e.g., every 0.01 seconds). While, in theory, the load curve should appear flat between the addition or removal of items from the shopping cart, in practice the load curve may be noisy. This may be due to the sensitivity of the load sensor itself, the item taking some time to settle in the storage area, or the movement of the shopping cart, for example as the shopping cart moves through the store. The item detection module 260 distinguished changes in the load curve due to noise from changes in the load curve due to the additional or removal of items by performing step detection. In performing step detection, the item detection module 260 determines when there is a change in the mean level of the load curve. The item detection module 260 may use convolution in step detection, for example by applying a convolutional model or convolving the signal with a unit step. In response to detecting a step, the item detection module 260 determines that an item has been added to or removed from the shopping cart.

In response to determining that an item has been added to the shopping cart 110, the item detection module 260 determines a timeframe that should be used by the detection system 130 to predict the weight of the item and identify the item. In some embodiments, the item detection module 260 may identify a timeframe that begins some predetermined amount of time before the item detection occurred and that ends some predetermined amount of time after the item detection occurred. For example, if the item detection module 260 determines that an item has been added to the shopping cart at time t0, the item detection module 260 may then determine that data within a timeframe of 200 milliseconds before t0 and 200 milliseconds after t0 should be used as input to a weight prediction model to predict the weight of the item or an item recognition model to identify the item. In some embodiments, the item detection module 260 may use images and load data received at the time the item was detected as inputs to a machine learning model that determines how broad a time range around the item detection time should be for providing further image and load data to item identification models (e.g., a timestamp detection model that identifies a set of timestamps that are most likely to correspond to the item being placed in the storage area of the shopping cart 110). The timeframe determined by the item detection module 260 makes it possible for the detection system 130 to analyze only input data that is important for predicting the identity of an item, rather than analyzing all input data as it is received.

The load prediction module 270 predicts the load of the newly added item. The load prediction module 270 obtains the load data that was collected from the load sensors 170 at time stamps during the timeframe that was determined by the item detection module 260 to be related to the item being added to the shopping cart 110. That is, the load prediction module 270 obtains a load curve for each of the load sensors 170 where the load curve includes the time series of load data recorded at each of the load sensors 170. In some embodiments, the load prediction module 270 predicts the load of the newly added item with load data from only one of the load sensors 170.

In some embodiments, the load prediction module 270 identifies the weight of the item by identifying when the load values of the load curve converge. The load prediction module 270 may identify when the load curve converges to within a threshold standard deviation from a final value. In some embodiments, the load prediction module 270 identifies when the load curve converges by applying a Kalman filter to the load curve. In some embodiments, the load prediction module 270 identifies when the load curve converges by applying a statistical model to the load curve. The load prediction module 270 may select a portion of the load curve (e.g., a time window), denoise the portion of the load curve (e.g., by applying a denoising algorithm), smooth the portion (e.g., with a moving average filter) and calculate a set of statistical metrics. Example statistical metrics may include the slope of the portion, the standard deviation of load measurements in the portion, or a range of load measurements in the portion. The load prediction module 270 inputs the calculated statistical metrics into the statistical model. The statistical model outputs a confidence score based on the statistical metrics. A high confidence score corresponds to high confidence that the portion of the load curve is stable and that the load curve has converged. The load prediction module 270 may identify the load measured by the load sensor at the time of convergence and also identify the load measured by the load sensor before the item was added to the cart. To identify the weight of the item, the load prediction module 270 subtracts the load measured before the item was added from the load measured at the time of convergence.

In some embodiments, the load prediction module 270 identifies the load of the item by applying a machine learning model trained to predict the weight of the item based on the load curve data. For example, the load prediction module 270 may apply the weight prediction model described with respect to the model training module 220. The load prediction module 270 need not apply the model to the entire load curve. In some embodiments, the load prediction module 270 may apply the model to a portion of the load curve, such as the first 100 milliseconds after the item was added to the shopping cart. The load prediction module 270 receives, as output from the model, a predicted weight of the item. In some embodiments, the load prediction model 270 receives a confidence score as output from the model. The confidence score represents the confidence that the predicted weight is the actual weight of the item. A high confidence score is a confidence score that meets or exceeds a confidence threshold (e.g., 95% confidence). The load prediction module 270 determines whether the confidence score meets or exceeds a confidence threshold. In response to the confidence score not exceeding a confidence threshold, the load prediction module 270 may make an additional prediction of the item weight by applying the machine learning model to a different portion of the load curve. For example, the load prediction module 270 may apply the model to a later portion of the load curve (e.g., from 100 milliseconds to 200 milliseconds after the item was added to the shopping cart) or to a longer portion of the load curve that may include the portion from the previous application of the model (e.g., from 0 milliseconds to 200 milliseconds after the item was added to the shopping cart). In some embodiments, in response to the confidence score not exceeding a confidence threshold, the load prediction module 270 may wait for the load curve to converge and may determine the weight of the item based on the load measurement at the time of convergence.

The item identification module 280 identifies the item that was added to the shopping cart 110. The item identification module 280 may identify the item based on the weight determined by the load prediction module 270 or based on image data from cameras 160. In some embodiments, the detection system 130 provides the load data from the determined timeframe and the image data from the determined timeframe to the item identification module 280 to identify the item that was added to the shopping cart 110. The item identification module 280 provides the load data and image data to a trained item recognition model. The item recognition model may use the load data information to identify the area of the shopping cart 110 where the item was placed. Relatedly, the item recognition model can use the load data to determine the portions of the image frames in the image data that are likely to include the newly added item. The item identification module 280 outputs a predicted identification (e.g., the identifier) of the item that was added to the shopping cart 110. In some embodiments, the item identification module 280 may use multiple models to identify the item. For example, the item identification module 280 may apply a model that takes in the load data and the image data from the determined time range and outputs one or more of the input image frames with bounding boxes around the area of the item that was added (or another location identifier). The item identification module 280 may then apply an image classification model to the portions of the image frames within the bounding boxes to identify the item (e.g., by detecting barcodes in the image data or otherwise analyzing the image data within the bounding boxes).

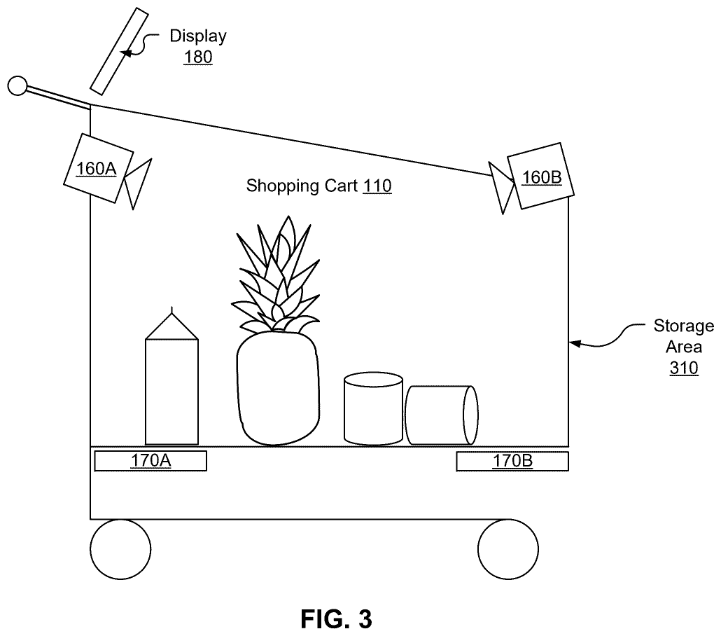

FIG. 3 is an illustration of a shopping cart 110, in accordance with one or more example embodiments. The shopping cart 110 includes cameras 160A and 160B, load sensors 170A and 170B, a display 180, and a storage area 310. In various embodiments, more or fewer cameras 160 and more or fewer load sensors 170 may be used in a shopping cart 110. The storage area 310 is used to hold items. For example, FIG. 3 shows a storage area 310 with two cans, a pineapple, and a carton of milk. The display 180 may provide information to the user of the shopping cart about the items inside the storage area 310, such as a list of the items, the total cost of the shopping cart contents, and any available coupons or discounts associated with the items in the shopping cart 110.

FIG. 4 is a high-level diagram of a process for applying a sensor fusion model 430. A sensor fusion model 430 may be one of the models used by the item recognition module 280 to predict a classification of the type of item that has been added to the shopping cart 110. Training the sensor fusion model 430 may be managed by the model training module 220 and may include providing labeled example inputs of image data and load data to the model and then updating the model parameters based on a comparison of the model output to the labels. In the example of FIG. 4, the sensor fusion model 430 is applied to load measurements 410 and images 420. The example load measurements 410 include load curves from each of four load sensors 170 on a shopping cart 110 that each detected load changes in the shopping cart storage area 310 when a pineapple was added to the shopping cart. The load measurements 410 are load data over the course of a timeframe (e.g., each load curve is set of load values taken at timestamps throughout the timeframe) associated with the pineapple being added to the shopping cart 110 (represented in FIG. 4 by load curves connecting the load data points). In some embodiments, the load measurements 410 and images 420 are provided as input to the sensor fusion model 430, which outputs a prediction 440 based on its current weight parameters.

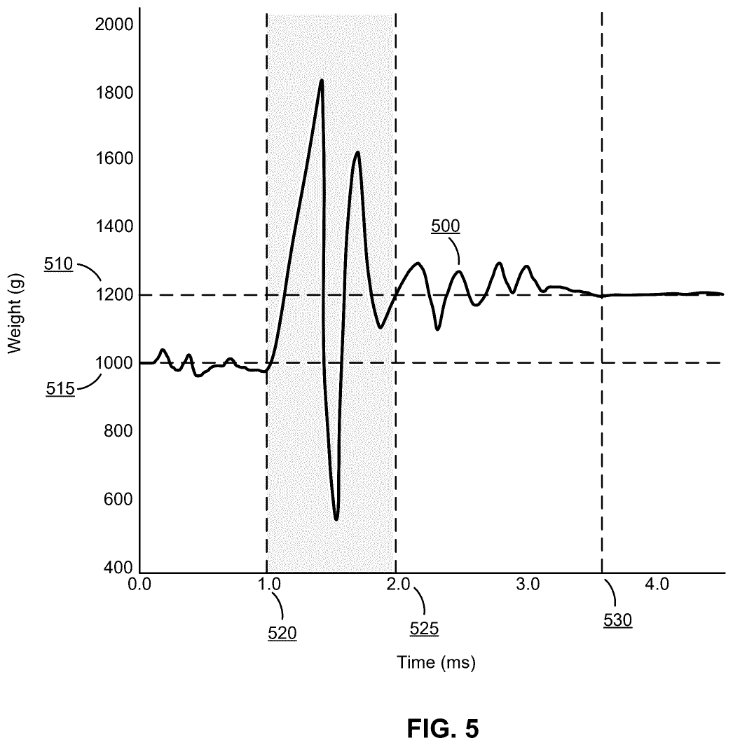

FIG. 5 illustrates a load curve, in accordance with one or more example embodiments. FIG. 5 illustrates an example load curve 500. From 0 to 100 milliseconds, the weight measured by the load sensor hovers around a first weight value 515, about 1000 grams. The small variation from the first weight value 515 may be attributed to sensor noise or be caused by small movements in the shopping cart. At a first time 520, around one second, an item is added to the shopping cart. The addition of the item of the shopping cart, which may be detected by the item detection module 260, causes the load values of the load curve to spike up and oscillate. The load values converge slowly over time, converging to within a threshold standard deviation of the final load value at a second time 530, around 3.6 seconds. After the second time 530, the load value is a second weight value 510, around 1200 grams. The detection system 130 may calculate the weight of the added item as the difference between the second weight value and the first weight value, 200 grams.

In some embodiments, the detection system 130 may predict the weight of the added item by waiting for the load curve to converge. Namely, the detection system 130 may wait from the time the item was added, the first time 520, to the time the load curve converges, the second time 530. In this example, the detection system 130 would wait for 2.6 seconds after the detection of the item.

In some embodiments, the detection system 130 may predict the weight of the added item based on the shape of the load curve. The detection system 130 may apply a weight prediction model to a portion of the load curve. For example, the detection system 130 may apply a weight prediction model to the portion of the load curve from the first time 520, around one second, to a third time 525, around two seconds. In applying a weight prediction model to a portion of the load curve, the detection system 130 predicts the weight of the added item in a shorter time (e.g., 1.0 seconds) than the time it takes for the weight of the load sensor to converge (e.g., 2.6 seconds).

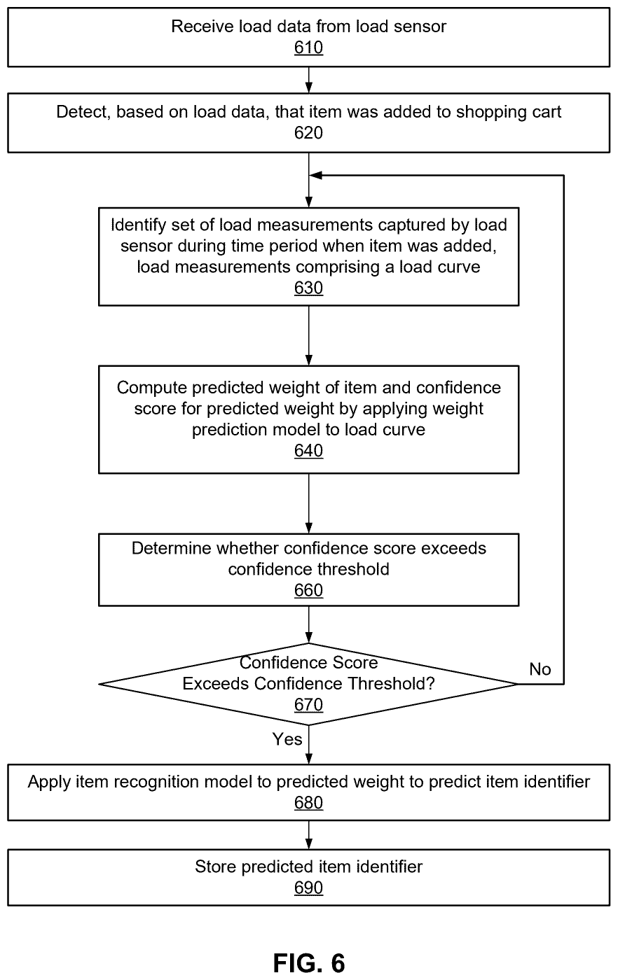

FIG. 6 is a flowchart illustrating an example method for predicting the weight of an item added to a shopping cart, in accordance with one or more example embodiments. Alternative embodiments may include more, fewer, or different steps and the steps may be performed in a different order from that illustrated in FIG. 6.

The detection system 130 receives 610 load data captured by a load sensor of a shopping cart. The load data from the load sensor 170 includes a load measurement sensed by the load sensor at each of a series of timestamps. The load measurements and their timestamps form a load curve. The detection system 130 detects 620 that an item was added to the storage area of the shopping cart during a time period. The detection system 130 identifies 630 a set of load measurements captured by the load sensor during the time period when the item was added. The identified set of load measurements make up a load curve. The detection system 130 computes 640 a predicted weight of the item by applying a weight prediction model to the load curve. The weight prediction model may output a predicted weight of the item, a confidence score corresponding to the predicted weight of the item, or both the weight of the item and a confidence score. The detection system 130 determines 660 whether the confidence score exceeds a confidence threshold. In response to the confidence score not exceeding 670 the confidence threshold, the detection system 130 repeats steps 630 through 660. More specifically, the detection system identifies a new set of load measurements captured by the load sensor and applies a machine learning model to the new load curve to receive a new prediction of the weight along with a new confidence score. This process may repeat until the confidence score associated with the prediction output by the machine learning model meets or exceeds the confidence threshold. In response to the confidence score exceeding 670 the confidence threshold, the detection system 130 applies 680 an item recognition model to the predicted weight to predict the item identifier. The item recognition model is a machine learning model that is trained to identify items based on load data from a plurality of load sensors. The detection system 130 stores 690 the predicted item identifier.

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A method, performed at a computing system comprising a processor and a memory, comprising:
receiving load data from a load sensor, wherein the load sensor is coupled to a storage area of a shopping cart, wherein the load data comprises load measurements captured by the load sensor, and wherein the load measurements are samples from the load sensor that form a timeseries;
detecting, based on the load data, that an item was added to the storage area of the shopping cart;
identifying a first set of load measurements captured by the load sensor during a first time period when the item was added;
computing a first predicted weight of the item and a confidence score for the first predicted weight by applying a weight prediction model to the first set of load measurements;
determining whether the confidence score exceeds a confidence threshold; and
responsive to the confidence score of the prediction not exceeding the confidence threshold:
identifying a second set of load measurements captured by the load sensor during a second time period when the item was added, wherein the second time period comprises the first time period; and
computing a second predicted weight of the item by applying the weight prediction model to the second set of load measurements.

2. The method of claim 1, further comprising:
applying an item recognition model to the first predicted weight of the item, wherein the item recognition model is a machine-learning model trained to predict an item identifier based on a weight of the item; and
storing the predicted item identifier.

3. The method of claim 2, further comprising;
determining a third predicted weight of the item based on a load measurement at a time when the first set of load measurements converges to within a threshold standard deviation from a final load value; and
responsive to the confidence score not exceeding the confidence threshold, applying the item recognition model to the third predicted weight of the item.

4. The method of claim 2, further comprising:
providing, for display at a user interface, an item name corresponding to the predicted item identifier and the first predicted weight of the item.

5. The method of claim 2, further comprising:
receiving image data from a camera, wherein the camera is coupled to the storage area of the shopping cart, and wherein the image data comprises an image frame captured at each of a series of timestamps;
wherein applying the item recognition model comprises applying the item recognition model to the image data.

6. The method of claim 1, wherein the weight prediction model is a transformer model.

7. The method of claim 6, further comprising:
training the weight prediction model based on a set of training examples, each training example comprising a load curve captured by the load sensor during a time period when an item was added and a ground truth weight of the item.

8. The method of claim 1, wherein computing the first predicted weight and the second predicted weight comprises:
computing the first predicted weight and the second predicted weight at the shopping cart.

9. The method of claim 8, wherein the weight prediction model is a statistical model, and wherein applying the weight prediction model to the first set of load measurements comprises:
applying a denoising algorithm to the first set of load measurements;
applying a smoothing algorithm to the first set of load measurements;
computing statistical metrics of the first set of load measurements; and
determining a confidence score based on the computed statistical metrics, the confidence score indicating whether the first set of load measurements have converged.

10. A non-transitory computer-readable storage medium storing executable instructions that, when executed by a hardware processor, cause the hardware processor to perform steps comprising:
receiving load data from a load sensor, wherein the load sensor is coupled to a storage area of a shopping cart, wherein the load data comprises load measurements captured by the load sensor, and wherein the load measurements are samples from the load sensor that form a timeseries;
detecting, based on the load data, that an item was added to the storage area of the shopping cart;
identifying a first set of load measurements captured by the load sensor during a first time period when the item was added;
computing a first predicted weight of the item and a confidence score for the first predicted weight by applying a weight prediction model to the first set of load measurements;
determining whether the confidence score exceeds a confidence threshold; and
responsive to the confidence score of the prediction not exceeding the confidence threshold:
identifying a second set of load measurements captured by the load sensor during a second time period when the item was added, wherein the second time period comprises the first time period; and
computing a second predicted weight of the item by applying the weight prediction model to the second set of load measurements.

11. The non-transitory computer-readable storage medium of claim 10, the steps further comprising:
applying an item recognition model to the first predicted weight of the item, wherein the item recognition model is a machine-learning model trained to predict an item identifier based on a weight of the item; and
storing the predicted item identifier.

12. The non-transitory computer-readable storage medium of claim 11, the steps further comprising:
determining a third predicted weight of the item based on a load measurement at a time when the first set of load measurements converges to within a threshold standard deviation from a final load value; and
responsive to the confidence score not exceeding the confidence threshold, applying the item recognition model to the third predicted weight of the item.

13. The non-transitory computer-readable storage medium of claim 11, the steps further comprising:
providing, for display at a user interface, an item name corresponding to the predicted item identifier and the first predicted weight of the item.

14. The non-transitory computer-readable storage medium of claim 11, the steps further comprising:
receiving image data from a camera, wherein the camera is coupled to the storage area of the shopping cart, and wherein the image data comprises an image frame captured at each of a series of timestamps;
wherein applying the item recognition model comprises applying the item recognition model to the image data.

15. The non-transitory computer-readable storage medium of claim 10, wherein the weight prediction model is a transformer model.

16. The non-transitory computer-readable storage medium of claim 15, the steps further comprising:
training the weight prediction model based on a set of training examples, each training example comprising a load curve captured by the load sensor during a time periods when an item was added and a ground truth weight of the item.

17. The non-transitory computer-readable storage medium of claim 10, wherein computing the first predicted weight and the second predicted weight comprises:
computing the first predicted weight and the second predicted weight at the shopping cart.

18. The non-transitory computer-readable storage medium of claim 17, wherein the weight prediction model is a statistical model and wherein the step for applying the weight prediction model to the first set of load measurements comprises:
applying a denoising algorithm to the first set of load measurements;
applying a smoothing algorithm to the first set of load measurements;
computing statistical metrics of the first set of load measurements; and
determining a confidence score based on the computed statistical metrics, the confidence score indicating whether the first set of load measurements have converged.

19. A computer system comprising:
a hardware processor; and
a non-transitory computer-readable storage medium storing executable instructions that, when executed, cause the hardware processor to perform steps comprising:
receiving load data from a load sensor, wherein the load sensor is coupled to a storage area of a shopping cart, wherein the load data comprises load measurements captured by the load sensor, and wherein the load measurements are samples from the load sensor that form a timeseries;
detecting, based on the load data, that an item was added to the storage area of the shopping cart;
identifying a first set of load measurements captured by the load sensor during a first time period when the item was added;
computing a first predicted weight of the item and a confidence score for the first predicted weight by applying a weight prediction model to the first set of load measurements;
determining whether the confidence score exceeds a confidence threshold; and
responsive to the confidence score of the prediction not exceeding the confidence threshold:
identifying a second set of load measurements captured by the load sensor during a second time period when the item was added, wherein the second time period comprises the first time period; and
computing a second predicted weight of the item by applying the weight prediction model to the second set of load measurements.

20. The computer system of claim 19, the steps further comprising:
applying an item recognition model to the first predicted weight of the item, wherein the item recognition model is a machine-learning model trained to predict an item identifier based on a weight of the item; and
storing the predicted item identifier.
